(19) United States
(12) Patent Application Publication
(10) Pub. No.: US 2026/0341988 A1
(43) Pub. Date: Oct. 29, 2026

(54) CONNECTOR FOR ATTACHING A CABLE TO A PRINTED CIRCUIT

(71) Applicant: VALEO SYSTEMES THERMIQUES, Le Mesnil-Saint-Denis (FR)

(72) Inventors: Anthony Brisset, Le Mesnil Saint Denis (FR); Philippe Mercier, Le Mesnil Saint Denis (FR); Hedi Krifa, Le Mesnil Saint Denis (FR)

(73) Assignee: VALEO SYSTEMES THERMIQUES, Le Mesnil-Saint-Denis (FR)

(21) Appl. No.: 19/122,151

(22) PCT Filed: Oct. 10, 2023
(86) PCT No.: PCT/EP2023/078068

§ 371 Date: Apr. 17, 2025

(30) Foreign Application Priority Data
Oct. 18, 2022 (FR) FR2210759

(51) Int. Cl. H01R 12/75; H01R 12/70; H01R 12/72; H01R 13/58; H02K 5/22

(52) U.S. Cl. CPC H01R 12/75; H01R 12/707; H01R 12/724; H01R 13/58; H02K 5/225; H02K 2211/03

(57) ABSTRACT

A connector for attaching a cable to a printed circuit, the connector is configured to be attached to an edge of the printed circuit. The connector includes: a first attachment portion for connecting the cable, and a second attachment portion for attaching the connector. The second attachment portion includes at least three tabs. The first and second attachment portions of the connector are connected by a longitudinal section extending perpendicularly to a plane of the printed circuit. The first attachment portion is located on the same side as a rear face of the printed circuit while the second attachment portion is located on the same side as the front face, and at least one of the three tabs passes through the printed circuit.

### TECHNICAL FIELD

The present invention relates to a connector for attaching a cable to a printed circuit. The invention also relates to the printed circuit comprising at least said connector, and to a three-phase motor comprising said printed circuit.

The invention relates to the technical field of cars, and more particularly three-phase motors of cars comprising at least one printed circuit with connectors.

### PRIOR ART

Cars generally comprise a motor with a cooling system which is essential for the thermal regulation of said motor. In a vehicle of recent design, such a cooling system generally comprises at least one cooling circuit positioned in contact with the motor and in which a coolant liquid flows. As the coolant liquid heats up, it will lower the temperature of the motor through heat exchange. When the temperature of the liquid reaches a threshold value, usually at least 90 °C, a fan is activated to lower the temperature of the liquid below that value.

The fan is therefore essential for thermal regulation of the motor. This fan generally comprises a propeller powered by a three-phase motor, itself controlled by a printed circuit. This printed circuit includes electrical and/or electronic components, which can trigger various functions within the motor. The power supply to the three-phase motor and its printed circuit is provided by one or more power cables.

The abovementioned cables are usually attached and held in position on an edge of the printed circuit by connectors. However, a high voltage applied to one of these cables can cause them to be torn off, which is detrimental to the electrical power supply to the three-phase motor.

For this reason, various connectors have been developed to improve the retention of a cable on the printed circuit. In particular, published patent document JP 2013-168312 A describes such a connector. This connector comprises three attachment tabs attached to one of the faces of the printed circuit, and an attachment portion mounted on said tabs. The attachment portion has a U-shaped section capable of receiving an electric cable, said portion being positioned perpendicularly to the plane of the printed circuit. However, this connector is bulky and fragile, and provides an unreliable connection to the cable.

Another type of connector is described in published patent document US 2016/0072200 A1. This connector is configured to be attached to the edge of the printed circuit and comprises a first attachment portion for attaching to said circuit and a second attachment portion for attaching to a cable. The cable is first inserted in a hole provided for this purpose on the edge of the printed circuit, then the connector is slid onto the printed circuit using the first attachment portion, and comes into contact with the cable, in such a way as to bend the cable to bring it parallel to the plane of the printed circuit. However, this connector is difficult to manufacture, and the electrical connection with the cable can be defective, because piercing of the cable to reach the conductive wires may not be performed properly.

The aim of the invention is to overcome at least one of the drawbacks of the abovementioned prior art. More particularly, the invention aims to reduce the space taken up by the connector on the printed circuit.

The invention also makes it possible to improve the resistance to mechanical stresses of the cable attached to the connector.

Another aim of the invention is to improve the electrical connection between the printed circuit and the power cables.

### Presentation of the Invention

The solution proposed by the invention is a connector for attaching a cable to a printed circuit, the connector being configured to be attached to an edge of the printed circuit, said connector comprising: a first attachment portion configured to connect the cable to the printed circuit, and a second attachment portion configured to attach the connector to the printed circuit, the second attachment portion comprising at least three tabs, the connector being attached to a part of the printed circuit which extends in a plane, the first and second attachment portions of the connector being connected by a longitudinal section extending perpendicularly to the plane of the printed circuit when the connector is mounted on said circuit, such that the first attachment portion is located on the same side as a rear face of the printed circuit while the second attachment portion is located on the same side as the opposite face, referred to as the front face, of the printed circuit, at least one of the three tabs being configured to pass through the printed circuit such that it can be attached by soldering.

The connector according to the invention makes it possible to mount a cable on a printed circuit. The position of the connector, with a first attachment portion oriented toward one of the faces of the printed circuit and a second attachment portion positioned on the opposite face of said circuit, makes it possible to reduce the space taken up by said connector. This therefore makes it possible to reduce the space required for the printed circuit, which saves on space for the installation of the three-phase motor.

The presence of three attachment tabs allows the connector to be balanced, particularly before soldering. To be specific, given its position on the edge of the printed circuit and its weight, the connector could easily tilt. Balancing the connector therefore allows efficient and easy soldering whatever the method used, in particular if the printed circuit has to be moved before soldering, notably so as to be placed in an oven.

Passing one of the tabs through the printed circuit makes it possible to improve the balance of the connector but also allows this tab to be soldered, thus also improving the mechanical strength and the electrical connection of the connector.

The soldering methods that may be used are known to those skilled in the art, and may, for example, be brazing, such as reflow soldering, or wave soldering. Some of these methods may therefore require passage through an oven.

Further advantageous features of the apparatus that forms the subject matter of the invention are listed hereinbelow. Each of these features may be considered alone or in combination with the notable features defined hereinabove. Each of these features contributes, as appropriate, to solving specific technical problems defined earlier on in the description, to which problems the notable features defined hereinabove do not necessarily contribute. These may, where appropriate, form the subject of one or more divisional patent applications:

According to a preferred embodiment of the invention, the three tabs of the second attachment portion are arranged such that they form an angle of 90° between them.

The arrangement of the tabs at 90° improves the balance of the connector in the absence of soldering, thus facilitating both the mounting of the connector on the printed circuit and the quality of the soldering.

According to a preferred embodiment of the invention, the three tabs of the second attachment portion comprise two lateral tabs and a rear tab, the rear tab having a section that is parallel to the edge of the printed circuit.

The lateral tabs are used firstly to improve the resistance of the connector to mechanical stresses, but also to improve the balance of said connector on the printed circuit. The rear tab is intended to allow electrical conductivity between the cable and the printed circuit.

According to a preferred embodiment of the invention, the second attachment portion comprises a retention segment connected to the longitudinal section of the connector and from which the three tabs extend.

The presence of a retention segment on the second attachment portion makes it possible to reduce the size of the connector, thus promoting correct positioning of the tabs on the printed circuit and holding it in place before soldering.

According to a preferred embodiment of the invention, the retention segment extends in a plane that is parallel to the plane of the printed circuit.

The fact that the retention segment extends in a plane that is parallel to the plane of the printed circuit makes it possible to reduce the space taken up by the connector on said circuit. The small size of the segment also makes it possible to limit the weight of the connector and facilitate retention thereof on the printed circuit.

Advantageously, the at least one of the three tabs soldered is the rear tab.

Advantageously, at least the rear tab is configured to allow electrical connection to the printed circuit.

The presence of a solder on the rear tab makes it possible to improve the electrical connection between the connector and the printed circuit. This solder also improves the resistance of the connector to stresses.

Advantageously, the tabs extend perpendicularly to the plane of the printed circuit.

The fact that the tabs are positioned perpendicularly to the plane of the printed circuit makes it easier to mount and solder the connector on said circuit.

Advantageously, all of the tabs are configured to pass through the printed circuit.

The fact that all of the tabs pass through the printed circuit makes it possible to improve the balance and retention of the connector on the printed circuit before soldering. It also makes it possible to facilitate soldering of one or more tabs on the circuit.

According to a preferred embodiment of the invention, the rear tab further comprises at least one bearing zone intended to bear against the printed circuit.

The bearing zone(s) of the rear tab make it possible to facilitate retention of the connector on the printed circuit before soldering, and then facilitate the soldering procedure by making it more reproducible and more efficient. Preferably, two bearing zones are formed on the rear tab.

According to a preferred embodiment of the invention, the longitudinal section of the connector further comprises at least one bearing zone intended to bear against the printed circuit.

The bearing zone(s) of the longitudinal section also make it possible to facilitate retention of the connector on the printed circuit before and during soldering of said connector. Preferably, two bearing zones are formed on the rear tab.

According to a preferred embodiment of the invention, the bearing zone of the rear tab or of the longitudinal section consists of a protruding section of square or rectangular shape.

The shape of the protruding sections is easy to produce when manufacturing the connector. The protruding sections also make it possible to facilitate the soldering procedure, making it more reproducible and efficient. The presence of protruding sections also makes it possible to limit the increase in weight of the connector.

Advantageously, all of the tabs are attached by soldering.

Adding solders to the lateral tabs makes it possible to improve the resistance of the connector to the mechanical stresses to which it is subjected.

Advantageously, the longitudinal section has a length of between 8 mm and 14 mm.

The length of the longitudinal section must be sufficient to support the two attachment portions and allow balancing of the connector. In addition, the connector must retain a degree of elasticity, which is important for its proper functioning and to improve resistance to the stresses exerted on the cable. The length of the longitudinal section also allows the spontaneous retention of the connector on the printed circuit in the absence of soldering.

Advantageously, the rear and lateral tabs have a length of between 4 mm and 6 mm, the lateral tabs have a width of between 1 mm and 2 mm, while the rear tab has a width of between 5 mm and 7 mm.

The lengths of the three tabs should preferably be similar in order to allow spontaneous retention of the connector on the printed circuit, and allow said connector to be balanced. Sufficient tab width enhances the robustness of the connector and allows sufficient electrical connection to the printed circuit, in the case of the rear tab.

Advantageously, the first attachment portion comprises: a flat bottom wall extending perpendicularly from the longitudinal section, a lateral wall extending from the bottom wall and constituting a U-shaped flap such that the flap and the bottom wall define a space configured to receive one end of the cable.

Forming the flap in the form of a U-shaped portion allows for a more lightweight connector, using less material. This portion also enhances the bond between the connector and the end of the cable, allowing for better retention of the cable on the printed circuit and a better electrical connection. Advantageously, the flap stops at a distance from an upper face of the flat bottom wall and at one edge, which allows the flap to retain a degree of elasticity in order to facilitate the crimping of the cable in the portion. Crimping is also facilitated by the U-shape of the flap. Crimping is the preferred method of attaching the cable to the connector because it is quick and easy to implement, known to those skilled in the art, and easily reproducible. However, other methods, known to those skilled in the art, may also be envisaged.

Advantageously, the U-shaped flap comprises two lateral branches connected to one another by a transverse branch, the lateral branches extending transversely to the bottom wall.

Transversely means that the lateral branches are positioned perpendicularly to the bottom wall.

Advantageously, the connector is made of metal or a metal alloy.

Advantageously, the connector is made of copper or a copper alloy.

A connector made of metal materials has several advantages. First of all, it makes it possible to facilitate electrical conduction between the cable and the printed circuit. Furthermore, the use of certain metal materials, such as copper, makes it possible to facilitate soldering of the connector to the printed circuit.

Copper alloy means an alloy which comprises a minimum percentage of copper of at least 5% by weight, more preferably a minimum percentage of copper of at least 50% by weight.

Advantageously, the second attachment portion is configured to be attached to either of the two faces of the printed circuit.

Soldering may thus be carried out on both sides of the circuit. Alternatively, the printed circuit may also be etched on both sides. The connector may therefore be placed on either of the faces as required.

The invention also relates to a printed circuit, said circuit comprising a structure supporting one or more electrical/electronic components, said circuit being configured to be electrically connected to one or more cables via at least one connector, the connector being according to the invention.

The connector allows the supply of electrical power to the printed circuit, and better resistance to mechanical stresses compared to prior art connectors.

Advantageously, the edge of the printed circuit has at least one notch or recess intended to allow the passage of the longitudinal section of the connector.

The presence of the notch allows the connector to be positioned correctly on the printed circuit. This will also allow the connector to be held in position, in particular by virtue of the presence of the bearing zones of the longitudinal section, these bearing zones being complementary to the edges of the notch.

Advantageously, the printed circuit comprises holes each having a shape and dimensions adapted to each of the tabs of the connector, the dimensions of each tab being respectively adapted to the passage of the corresponding hole such that the tabs are inserted in said hole.

The term “adapted” means that the holes have dimensions equal or nearly equal to the corresponding tab, such that the tab is spontaneously retained in the hole. Each of the holes makes it possible to receive one of the tabs of the corresponding connector, so as to solder at least one of the tabs for electrical connection, or to allow better resistance to mechanical stresses.

Advantageously, the printed circuit comprises a plurality of connectors, advantageously at least four connectors.

The presence of the various connectors makes it possible to supply power through several cables, which allows the control and/or the power supply of the motor mounted on the printed circuit. Advantageously, the size of the connectors is adaptable to the size of the cables that have to be connected to the printed circuit.

Preferably, the size of the cables depends on their function. Thus, at least two variants of the connectors according to the invention are described herein, capable of receiving two different sizes of cable. The connectors receiving power supply cables may be larger than the connectors for signal transmission cables.

The invention also relates to a three-phase motor comprising at least one printed circuit, said printed circuit being according to the invention.

Likewise, connectors of various sizes may be used in many different motors and/or different printed circuits, as required.

Advantageously, the electrical connection may be made by techniques known to those skilled in the art, such as for example by crimping, or by soldering.

### BRIEF DESCRIPTION OF THE FIGURES

Other advantages and features of the invention will appear more clearly on reading the description of a preferred embodiment set out below, with reference to the appended drawings, which are provided by way of non-limiting illustrative examples and in which:

FIG. 1a is a perspective view of a connector according to a first variant embodiment of the invention, the connector being positioned as mounted on a printed circuit.

FIG. 1b is a perspective view of the connector according to the first variant embodiment of the invention, the connector being inverted with respect to its direction of mounting on the printed circuit.

FIG. 2 is a perspective view of the connector according to the first variant embodiment of the invention, mounted on a printed circuit.

FIG. 3a is a perspective view of a connector according to a second variant embodiment of the invention, the connector being positioned as mounted on a printed circuit.

FIG. 3b is a perspective view of the connector according to the second variant embodiment of the invention, the connector being inverted with respect to its direction of mounting on the printed circuit.

FIG. 4 is a perspective view of the connector according to the second variant embodiment of the invention, mounted on a printed circuit.

FIG. 5 is a view of the connectors according to the first and second variant embodiments of the invention, mounted on the printed circuit and attached to the power cables.

FIG. 6 is another view of the connectors according to the first and second variant embodiments of the invention, attached to the power cables.

FIG. 7 shows the position of the solder paste on the printed circuit, for each of the connectors according to the two variant embodiments of the invention.

### DESCRIPTION OF THE EMBODIMENTS

As used herein, and unless stated otherwise, the use of the ordinal adjectives “first”, “second”, etc., to describe an object merely indicates that different instances of similar objects are being referred to and does not imply that the objects so described must be in any given sequence, whether in time, space, order of rank, etc. “X and/or Y” means: X alone or Y alone or X+Y. In general, it will be appreciated that, in the various attached figures, the objects have been drawn arbitrarily to make the drawings easier to read.

In the present application, the axis “x” designates the direction of mounting of the connector on the printed circuit along a horizontal axis, from the inside to the outside of said circuit. The axis “y” refers to the direction in which the connector is mounted on the printed circuit along a vertical axis, from bottom to top.

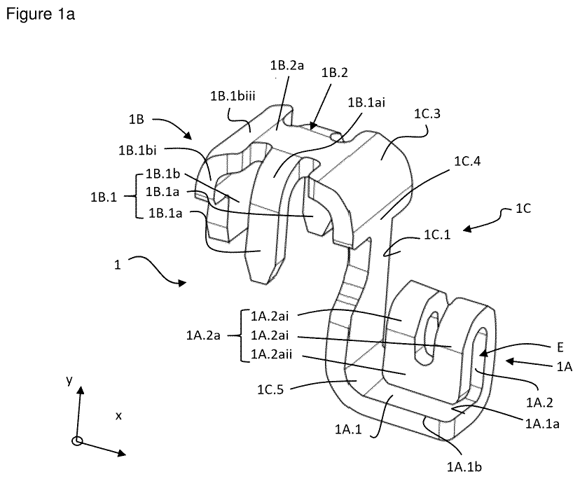

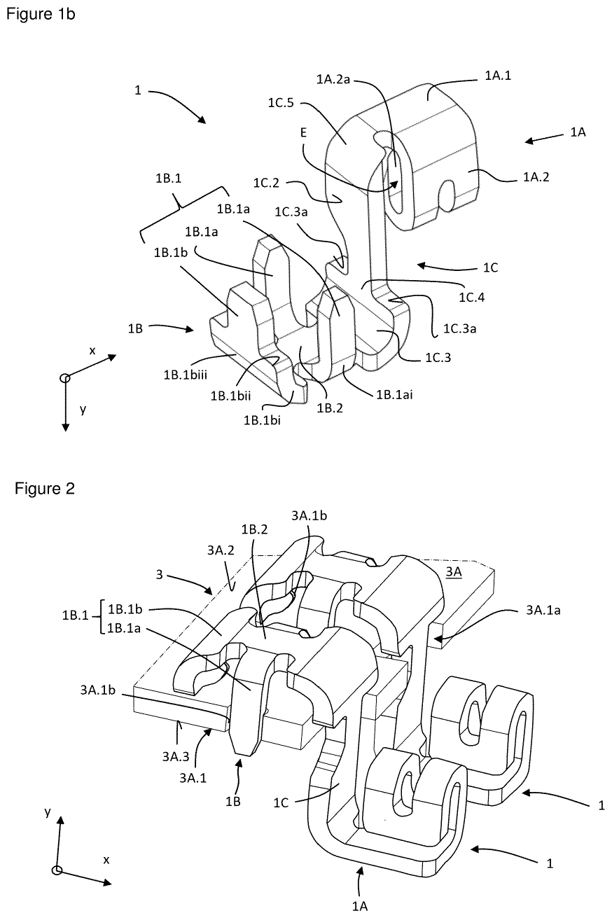

FIGS. 1a and 1b show two perspective views of a connector according to a first variant embodiment of the invention.

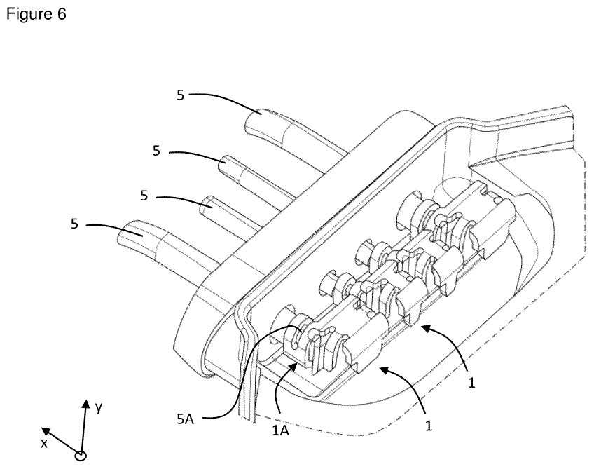

A connector 1 according to the invention comprises a first attachment portion 1A for receiving an end of an electrical power supply cable (said cable being visible in FIGS. 5 and 6). This first portion 1A may comprise a flat bottom wall 1A.1 which extends in a direction parallel to the axis x, this flat bottom wall 1A.1 having a length preferably of between 3 mm and 6 mm, and a width of between 2 mm and 6 mm.

This first attachment portion 1A may also include a lateral wall 1A.2 which extends from the flat bottom wall 1A.1, therefore in the direction of the axis y. The lateral wall 1A.2 is extended by a U-shaped flap 1A.2a, said flap 1A.2a stopping at a distance from an upper face 1A.1a of the flat bottom wall 1A.1, and at the height of an edge 1A.1b of said wall 1A.1. The assembly comprising the flap 1A.2a and the lateral wall 1A.2 delimits a space E configured to receive the cable. In particular, this space E has a width of between 1 mm and 5 mm and a height of between 4 mm and 8 mm. This space E may more specifically be adapted to the power cable that the first attachment portion 1A is to receive.

More specifically, the U-shaped flap 1A.2a comprises two lateral branches 1A.2ai connected to one another by a transverse branch 1A.2aii. The lateral branches 1A.2ai extend transversely to the flat bottom wall 1A.1, in other words the lateral branches 1A.2ai extend perpendicularly to the bottom wall 1A.1, with a possible variation of plus or minus 5°owing to manufacturing and assembly constraints.

The connector 1 further comprises a second attachment portion 1B for mounting said connector 1 on a printed circuit (said circuit not being visible in FIGS. 1a and 1b). More particularly, this second attachment portion 1B comprises at least three tabs 1B.1 allowing the attachment of the connector 1 to the printed circuit. The three tabs 1B.1 extend from a retention segment 1B.2 which extends along the axis x.

More specifically, the three tabs 1B.1 are advantageously positioned to form an angle of 90° between them, this angle possibly varying by plus or minus 5° depending on the manufacturing constraints and/or constraints involved in mounting the connector 1 on the printed circuit. The specific location of these tabs 1B.1 notably makes it easier to position the connector 1 correctly on the printed circuit.

Preferably, the three tabs 1B.1 of the second attachment portion 1B comprise two lateral tabs 1B.1a which extend on either side of, and perpendicularly to, the retention segment 1B.2, therefore parallel to the axis y. The lateral tabs 1B.1a have a curvature at their upper ends 1B.1ai of approximately 90°, plus or minus 5° depending on the manufacturing constraints of the connector 1 and its positioning. This curvature allows the lateral tabs 1B.1a to be oriented correctly to promote the anchoring of the connector 1 on the printed circuit. Advantageously, the lateral tabs 1B.1a have a length of between 4 mm and 6 mm, and a width of between 1 mm and 2 mm. The lateral tabs 1B.1a are mainly provided to improve the balance of the connector 1, and to improve the resistance of said connector 1 to mechanical stresses. The lateral tabs 1B.1a may optionally be provided to make an electrical connection with the printed circuit.

The three tabs 1B.1 of the second attachment portion 1B further comprise a rear tab 1B.1b the section of which is perpendicular to the direction of the axis x. The rear tab 1B.1b extends from a rear end 1B.2a of the retention segment 1B.2, said tab 1B.1b therefore being continuous with said segment 1B.2. The rear tab 1B.1b also has a curvature at an upper end 1B.1bi of approximately 90°, plus or minus 5° depending on the manufacturing constraints of the connector 1 and its positioning on the printed circuit. In a particularly preferred manner, the rear tab 1B.1b makes the electrical connection between the cable and the printed circuit. The rear tab 1B.1b further comprises at least one bearing zone 1B.1bii which will bear on the printed circuit. This bearing zone 1B.1bii is advantageously positioned on a protruding section 1B.1biii of preferably square or rectangular shape. More preferably, the rear tab 1B.1b comprises two bearing zones 1B.1bii. The presence of two bearing zones 1B.1bii on the rear tab 1B.1b improves the stability of the connector 1. The rear tab 1B.1b advantageously has a length of between 4 mm and 6 mm and a width of between 5 mm and 7 mm.

More specifically, the retention segment 1B.2 of the second attachment portion 1B preferably extends, in the lengthwise direction, parallel to the direction of the axis x. Advantageously, the retention segment 1B.2 is located at a distance from the printed circuit of between 0.5 mm and 5 mm, more preferably between 0.5 mm and 1.5 mm. This relatively short distance makes it possible to reduce the bulk of the connector 1, and therefore to reduce the bulk of the printed circuit.

Lastly, the connector 1 according to the invention comprises a longitudinal section 1C connecting together the first and second attachment portions (1A, 1B) of said connector 1. This section 1C extends in the direction of its length, therefore in the direction of the axis y. Thus, the first and second attachment portions (1A, 1B) of the connector 1 extend in the direction of the axis x and perpendicularly to the longitudinal section 1C. “Perpendicularly” means that the longitudinal section 1C extends at an angle of 90° relative to the direction of the axis “x”, with a variation of plus or minus 5° owing to the vagaries of manufacture and attachment of the connector 1. More particularly, the first attachment portion 1A extends from a first face 1C.1 of the longitudinal section 1C, and more specifically, said portion 1A extends perpendicularly from said section 1C. The second attachment portion 1B conversely extends from a second face 1C.2 of the longitudinal section 1C opposite the first face 1C.1 of said section 1C. The retention segment 1B.2 therefore extends from the longitudinal section 1C, and perpendicularly thereto.

This section 1C further comprises, at an upper end 1C.4, a protruding section 1C.3 of square or rectangular shape. At this section 1C.3 there is a bearing zone 1C.3a which comes into contact with the printed circuit. Preferably, at least two bearing zones 1C.3a are found on the longitudinal section 1C. These bearing zones 1C.3a are intended to help retain the connector 1 on the printed circuit. More preferably, the longitudinal section 1C of the connector 1 has a length of between 8 mm and 14 mm. The longitudinal section 1C of the connector 1 further comprises a curved lower end 1C.5, which is attached to the second attachment portion 1B of said connector 1. This curvature, of approximately 90°, with a possible variation of plus or minus 5° owing to the vagaries of manufacture and mounting, allows the second portion 1B to be positioned correctly, perpendicularly to the longitudinal section 1C, and makes it possible to facilitate the positioning of the connector 1 on the printed circuit.

Advantageously, in order to facilitate the electrical conductivity of the connector 1, the latter is preferably made of metal or a metal alloy. More preferably, the connector 1 is made of copper or copper alloy. Copper alloy means an alloy which comprises a minimum percentage of copper of at least 5% by weight, and more preferably of at least 50% by weight.

FIG. 2 is a view of the connector of FIGS. 1a and 1b, mounted on a printed circuit.

The printed circuit 3 according to the invention is generally composed of at least one structure 3A on which electrical and/or electronic components are mounted (said components not being visible in FIG. 2). A connector 1 according to the invention is used to electrically connect the printed circuit 3 to a cable (the cable not being visible in FIG. 2). Thus, the printed circuit 3 may be electrically connected to one or more cables, each cable being connected to said circuit 3 by means of a connector 1. Preferably, the printed circuit 3 comprises a plurality of connectors 1, and particularly preferably, the printed circuit 3 comprises four connectors 1.

A connector 1 according to the invention is specifically designed to be mounted on an edge 3A.1 of the structure 3A of the printed circuit 3, hence the importance of balancing the connector 1, so that it does not tilt before it is soldered on said circuit 3. More particularly, the edge 3A.1 of the printed circuit 3 corresponds to an external part of the printed circuit 3 of less than 5 mm, more preferably less than 3 mm. The edge 3A.1 of the structure 3A forms a part of the printed circuit 3 which extends in a plane passing through the axis x. This plane is therefore perpendicular to the longitudinal section 1C of the connector 1, when said connector 1 is mounted on the printed circuit 3.

In addition, the edge 3A.1 of the printed circuit 3 has one or more notches 3A.1a, or recesses. In the remainder of the description of FIG. 2, only the term notch will be used for the sake of simplification, and may designate, indifferently, a notch or a recess. Each notch 3A.1a may receive one of the connectors 1 according to the invention via its longitudinal section 1C. In particular, in the case of a connector 1 according to the first variant embodiment of the invention, the notch 3A.1a has a width of between 2 mm and 6 mm. This notch 3A.1a must advantageously be large enough to accommodate the longitudinal section 1C of the connector 1, without however allowing the connector 1 to tilt before soldering. The width of the notch 3A.1a must therefore more preferably be slightly greater than that of the longitudinal section 1C of the connector 1. Advantageously, the depth of the notch 3A.1a must be sufficient to accommodate the thickness of the longitudinal section 1C, in order to guarantee a maximum reduction in bulk.

The edge 3A.1 of the printed circuit 3 further comprises holes 3A.1b which have shapes and/or dimensions adapted to each tab (1B.1, 1B.1a, 1B.1b) of the connector 1, each of the tabs (1B.1, 1B.1a, 1B.1b) being inserted in one of the corresponding holes 3A.1b. “Holes 3A.1b which have shapes and/or dimensions adapted” means holes 3A.1b which have dimensions equal or almost equal to the dimensions and/or shapes of the corresponding tab (1B.1, 1B.1a, 1B.1b), such that said tab (1B.1, 1B.1a, 1B.1b) is retained in said hole 3A.1b. Therefore, owing to the difference in size between the lateral tabs 1B.1a and the rear tab 1B.1b, the hole 3A.1b for the rear tab 1B.1b will be significantly wider than a hole 3A.1b for one of the lateral tabs 1B.1a. Preferably, the rear tab 1B.1b and the corresponding hole 3A.1b have a section that is parallel to the edge 3A.1 of the printed circuit 3. “Section that is parallel” means that the direction of the section of the rear tab 1B.1b and of the hole 3A.1b is positioned parallel to the edge 3A.1 of the printed circuit 3.

The structure 3A of the printed circuit 3 also comprises a front face 3A.2 and a rear face 3A.3. The first attachment portion 1A of the connector 1 extends on the rear face 3A.3 side, and the second attachment portion 1B of the connector 1 is attached to the front face 3A.2, or face opposite the rear face 3A.3 of said circuit 3. “Rear face” 3A.3 means the face of the printed circuit 3 positioned on the cable side, while “front face” 3A.2 means the face opposite the rear face 3A.3, and on which the second attachment portion 1B of the connector 1 is attached.

More specifically, the retention segment 1B.2 of the second attachment portion 1B follows a plane that is parallel to the plane of the printed circuit 3. “Plane that is parallel” means a plane substantially parallel to the plane of the printed circuit 3, therefore oriented along the axis x.

Thus, the tabs (1B.1, 1B.1a, 1B.1b) of the connector 1, which are oriented at 90° relative to the retention segment 1B.2, extend perpendicularly to the plane of the printed circuit 3. Advantageously, at least one of the tabs (1B.1, 1B.1a, 1B.1b) passes through the printed circuit 3 via one of the holes 3A.1b, such that it can be attached by soldering. More preferably, all of the tabs 1B.1 pass through the printed circuit 3, which facilitates soldering and makes it possible to improve the stability of the connector 1 mounted on said circuit 3 before soldering.

Alternatively, the second attachment portion 1B may be mounted on the rear face 3A.3 of the printed circuit 3. In this case, the first attachment portion 1A will be positioned on the front face 3A.2 side.

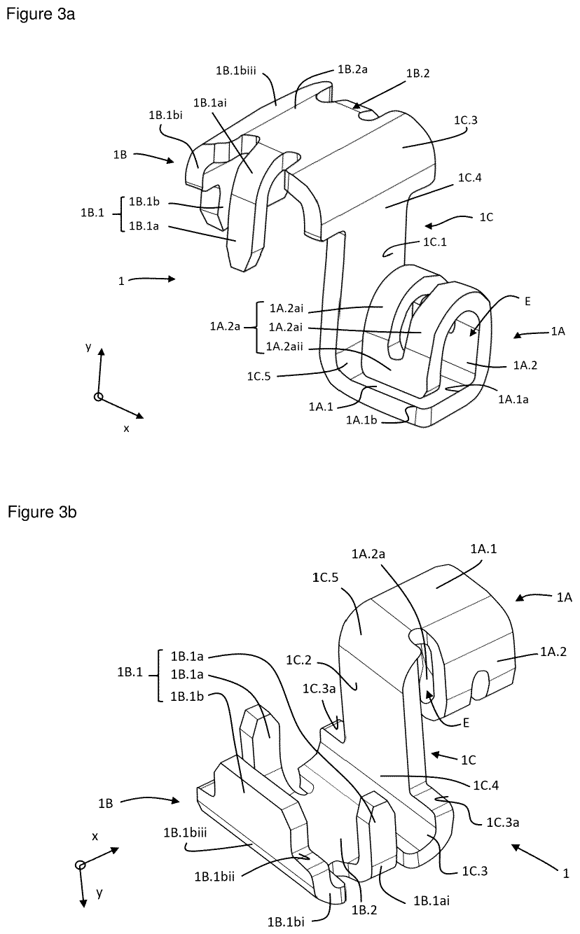

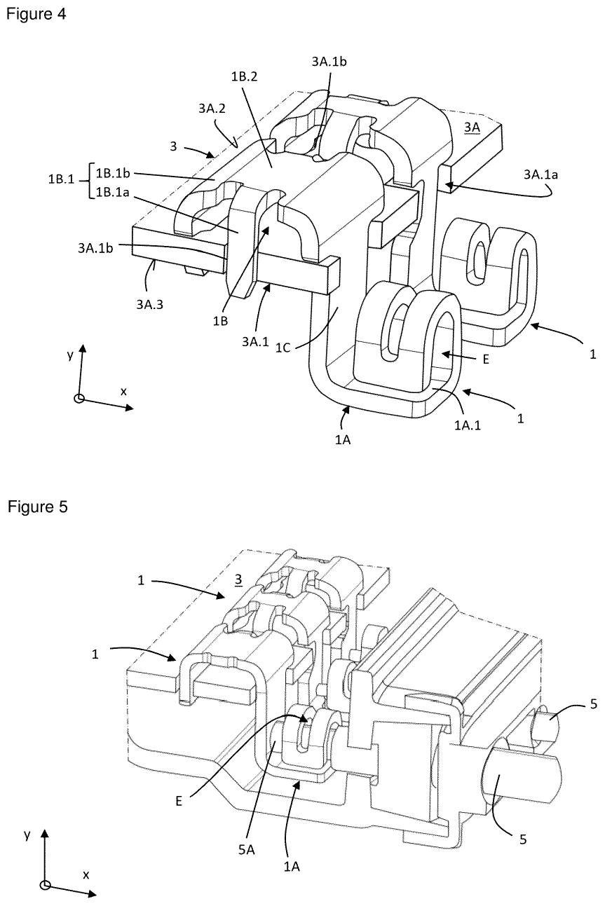

FIGS. 3a, 3b and 4 show views of a connector according to a second variant embodiment of the invention, mounted or not mounted on the printed circuit.

In this variant, the connector 1 has the same general features as the connector 1 of the first variant described in FIGS. 1a, 1b and 2. To be specific, the shape of this connector 1 is substantially the same. For the sake of simplification, only the differences with respect to the connector 1 of the first variant embodiment of the invention will be described.

Thus, the space E of the first attachment portion 1A, configured to accommodate the power cable, has a width preferably of between 4 mm and 8 mm, and a height preferably of between 4 mm and 8 mm. The length of the bottom wall 1A.1 of said first portion 1A is preferably between 4 mm and 8 mm. Furthermore, the length of the tabs 1B.1 of the second attachment portion 1B is advantageously between 2 mm and 6 mm, so as to stabilize the connector 1 on the printed circuit 3. More specifically, the width of the lateral tabs 1B.1a is between 1 mm and 2 mm, and the width of the rear tab 1B.1b is between 4 mm and 8 mm. Preferably, the longitudinal section 1C of the connector 1 has, in this variant, a length of between 8 mm and 14 mm. Advantageously, the retention segment 1B.2 of the second portion 1B is located at a distance from the front face 3A.2 of the printed circuit 3 of between 0.5 mm and 5 mm.

Lastly, these figures show that, in the case of a connector 1 according to the second variant embodiment of the invention, the notch 3A.1a located in the structure 3A of the printed circuit 3 has a width of between 3 mm and 8 mm, so as to accommodate the longitudinal section 1C of the connector 1, while limiting any risk of tilting of said connector 1.

This connector 1 is more robust and can accommodate larger cables.

FIGS. 5 and 6 show two views of the connectors according to the first and second variant embodiments of the invention, mounted on the printed circuit (FIG. 5 only) and connected to the cables (FIGS. 5 and 6).

In these figures, the first attachment portion 1A of the two variant connectors 1 surrounds, in each case, a stripped end 5A of a cable 5, in such a way as to connect said cable 5 to the printed circuit 3. In particular, this end 5A is inserted in the space E of the first attachment portion 1A of the connector 1. This first portion 1A is thus preferentially crimped around the stripped end 5A, in other words it will be clamped on said end 5A by means of pliers. This technique is widely known and used by those skilled in the art.

In addition, the two variant connectors 1 do not necessarily accommodate the same size of cable 5. Thus, either variant may be used as required.

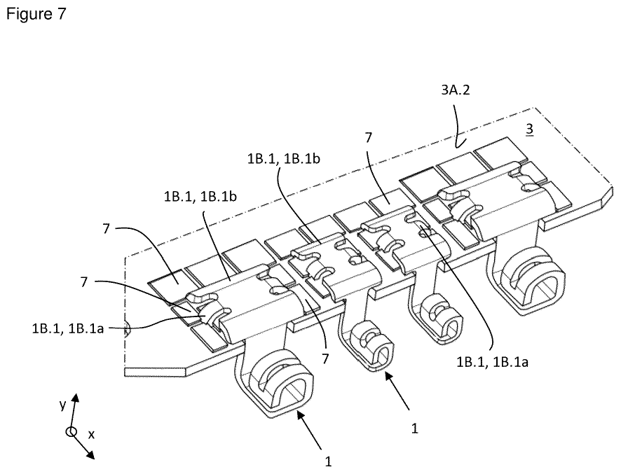

FIG. 7 shows the position of the solder paste on the printed circuit, for the two variant connectors according to the invention.

In the context of the invention, at least one of the three tabs (1B.1, 1B.1a, 1B.1b) of the connectors 1 is soldered to the printed circuit 3. The rear tab 1B.1b is particularly preferred to be soldered. Advantageously, the lateral tabs 1B.1a may also be soldered. Therefore, all of the tabs 1B.1 may be soldered to the printed circuit 3. This figure shows an example of the positioning of the solder paste, when all of the tabs (1B.1, 1B.1a, 1B.1b) of the connectors 1 are to be soldered. Soldering the three attachment tabs (1B.1, 1B.1a, 1B.1b) improves the resistance to stresses of the connector 1.

Various methods may be used to attach the connectors 1 to the printed circuit 3. The particularly preferred method is soldering by brazing, in particular reflow soldering.

Thus, at least two portions of solder paste 7 are positioned on the front face 3A.2 of the printed circuit 3 and around each of the lateral 1B.1a and rear 1B.1b tabs. Preferably, the two portions 7 are positioned on each side of one of the tabs (1B.1, 1B.1a, 1B.1b). The soldering, carried out with two portions of solder paste 7 per tab (1B.1, 1B.1a, 1B.1b), is particularly suitable for a connector 1 according to the first variant embodiment of the invention. Preferably, the desired volume of solder paste 7 is between 2.5 mm³ and 3.5 mm³ for each lateral tab 1B.1a. More preferably, the desired volume of solder paste 7 is around 3 mm³. In the case of the rear tab 1B.b, the desired volume of solder paste 7 is between 4 mm³ and 6 mm³, more preferably around 5 mm³.

Preferably, for the connector 1 according to the second variant embodiment of the invention, the desired volume of solder paste 7 is between 4 mm³ and 6 mm³, for each lateral tab 1B.1a. More preferably, the desired volume is around 5 mm³. In the case of the rear tab 1B.1b, the desired volume of solder paste 7 is between 9 mm³ and 12 mm³, more preferably around 11 mm³. In the case of the second variant embodiment of the connector 1, the number of portions of solder paste 7 will also be increased, since the volume of paste 7 is larger. Thus, three portions 7 per lateral tab 1B.1a and for the rear tab 1B.1b are desirable.

For both variant connectors 1, this volume may also change depending on the shape and/or dimension chosen for each of the tabs (1B.1, 1B.1a, 1B.1b). Those skilled in the art will measure the preferable quantity according to these characteristics.

During brazing, the solder paste 7 will enter by capillarity into the hole (not visible in this figure) in such a way as to solder the corresponding tab (1B.1, 1B.1a, 1B.1b) to the printed circuit 3. The two portions of solder paste 7 allow the solder to surround the entire tab (1B.1, 1B.1a, 1B.1b). This type of soldering allows for better reliability and repeatability of the procedure. Soldering is more efficient, more durable and better controlled. Preferably, the material chosen for carrying out the soldering is copper.

Alternatively, soldering may be carried out on the rear face (not visible in this figure) of the printed circuit 3. This soldering may be carried out in particular by wave soldering, or by other methods known to those skilled in the art. In this case, it is important that one of the tabs (1B.1, 1B.1a, 1B.1b) protrude so as to hold the connector 1 in place before and/or during soldering.

Alternatively, if the positions of the connector(s) 1 are reversed, the soldering may also be reversed.

The invention also relates to a three-phase motor comprising at least one printed circuit and at least one of the connectors according to one of the variant embodiments of the invention. The motor is not shown in these figures. While the connectors according to the invention are particularly suitable for use in a three-phase motor activating a fan, it may be envisaged that the connectors be used for other purposes, such as for mounting cables on any type of printed circuit, without necessarily being limited to cars and/or three-phase motors.

The arrangement of the various elements and/or means and/or steps of the invention, in the embodiments described hereinabove, must not be interpreted as demanding such an arrangement in all implementations. In any case, it will be appreciated that various modifications may be made to these elements and/or means and/or steps without departing from the spirit and scope of the invention.

Furthermore, one or more of the features set out in just one embodiment may be combined with one or more other features set out in just one other embodiment. Likewise, one or more features set out in just one embodiment may be generally applied to the other embodiments, even if this or these features are described only in combination with other features.

The use of the verb “comprise” or “include” and conjugated forms thereof does not rule out the presence of other elements or other steps in addition to those stated in a claim.

1. A connector for attaching a cable to a printed circuit, wherein the connector is configured to be attached to an edge of the printed circuit, said connector comprising:
a first attachment portion configured to connect the cable to the printed circuit; and
a second attachment portion configured to attach the connector to the printed circuit,
wherein the second attachment portion comprising at least three tabs,
wherein the connector is attached to a part of the printed circuit which extends in a plane,
wherein the first and second attachment portions of the connector are connected by a longitudinal section extending perpendicularly to the plane of the printed circuit when the connector is mounted on said circuit, such that the first attachment portion is located on the same side as a rear face of the printed circuit while the second attachment portion is located on the same side as the opposite face, referred to as a front face, of the printed circuit,
wherein at least one of the three tabs is configured to pass through the printed circuit such that it can be attached by soldering.

2. The connector for attaching a cable as claimed in claim 1, wherein the three tabs of the second attachment portion are arranged such that they form an angle of 90° between them.

3. The connector for attaching a cable as claimed in claim 1, wherein the three tabs of the second attachment portion comprise two lateral tabs and a rear tab, wherein the rear tab having a section that is parallel to the edge of the printed circuit.

4. The connector for attaching a cable as claimed in claim 1, wherein the second attachment portion comprises a retention segment connected to the longitudinal section of the connector and from which the three tabs extend.

5. The connector for attaching a cable as claimed in claim 4, wherein the retention segment extends in a plane that is parallel to the plane of the printed circuit.

6. The connector for attaching a cable as claimed in claim 3, wherein the rear tab further comprises at least one bearing zone configured to bear against the printed circuit.

7. The connector for attaching a cable as claimed in claim 1 wherein the longitudinal section of the connector further comprises at least one bearing zone configured to bear against the printed circuit.

8. The connector for attaching a cable as claimed in claim 6 wherein the bearing zone of the rear tab or of the longitudinal section consists of a protruding section of square or rectangular shape.

9. A printed circuit, said printed circuit comprising a structure supporting one or more electrical/electronic components, said printed circuit is configured to be electrically connected to one or more cables via at least one connector, wherein the connector is as claimed in claim 1.

10. A three-phase motor comprising at least one printed circuit, wherein said printed circuit is as claimed in claim 9.
